(19) United States
(12) Patent Application Publication
(10) Pub. No.: US 2026/0088236 A1
(43) Pub. Date: Mar. 26, 2026

(54) OPERATION DEVICE

(71) Applicant: KABUSHIKI KAISHA TOKAI-RIKA-DENKI-SEISAKUSHO, Aichi (JP)

(72) Inventors: Yuki TERAO, Niwa-gun (JP); Yuki SAKAI, Niwa-gun (JP); Yusuke NOMURA, Niwa-gun (JP); Yohei HASHIMOTO, Niwa-gun (JP)

(73) Assignee: KABUSHIKI KAISHA TOKAI-RIKA-DENKI-SEISAKUSHO, Aichi (JP)

(21) Appl. No.: 19/337,337

(22) Filed: Sep. 23, 2025

(30) Foreign Application Priority Data
Sep. 26, 2024 (JP) 2024-166935

(51) Int. Cl. H01H 13/10; B60K 35/10; H01H 13/14; H01H 25/00

(52) U.S. Cl. CPC H01H 13/10; B60K 35/10; H01H 13/14; H01H 25/006; B60K 2360/126

(57) ABSTRACT

An operation device includes an operating portion that includes a first conductive material and receives an operation by a user, and an operation support portion that at least partly includes a second conductive material, supports the operating portion in an insulated state and also displaces in an operating direction in conjunction with the operating portion due to an operation of the user, and electrostatically couples to the operating portion due to a contact of the user with the operating portion.

### CROSS-REFERENCE TO RELATED APPLICATIONS

The present patent application claims the priority of Japanese patent application No. 2024/166935 filed on Sep. 26, 2024, and the entire contents of Japanese patent application No. 2024/166935 are hereby incorporated by reference.

### TECHNICAL FIELD

The present invention relates to an operation device.

### BACKGROUND ART

An input device is known which includes operating knobs, electrodes being provided inside the operating knobs and detecting contact of an operating object, and a control unit being connected to the electrodes and detecting contact of the operating object with the operating knobs based on changes in capacitance of the electrodes (see, e.g., Patent Literature 1).

In the input device, the electrodes are electrically connected to operating portions through electric wires.

### CITATION LIST

### Patent Literatures

Patent Literature 1: JP 2015/109212A

### SUMMARY OF INVENTION

The known input device uses many components and has a high manufacturing cost since the electrodes are attached to the operating knobs with adhesive tape or glue and the electric wires are connected to the electrodes.

It is an object of the invention to provide an operation device that can suppress manufacturing costs.

An aspect of the invention provides an operation device, comprising:
an operating portion that comprises a first conductive material and receives an operation by a user; and
an operation support portion that at least partly comprises a second conductive material, supports the operating portion in an insulated state and also displaces in an operating direction in conjunction with the operating portion due to an operation of the user, and electrostatically couples to the operating portion due to a contact of the user with the operating portion.

### ADVANTAGEOUS EFFECTS OF INVENTION

According to an embodiment of the invention, it is possible to suppress manufacturing costs.

### BRIEF DESCRIPTION OF DRAWINGS

FIG. 1A is an explanatory diagram illustrating an example arrangement of an operation device.

FIG. 1B is an explanatory diagram illustrating an example of installation of the operation device.

FIG. 2A is an example cross-sectional view showing the operation device.

FIG. 2B is a cross-sectional view showing an example of contact between a shaft portion and a connection terminal.

FIG. 3A is an enlarged view showing an example of a first portion in the operation device.

FIG. 3B is an enlarged view showing an example of a second portion.

FIG. 4A is an explanatory diagram illustrating an example of electrical connection between the shaft portion and the connection terminal.

FIG. 4B is an example block diagram showing the operation device.

### DESCRIPTION OF EMBODIMENTS

### Short Summary of the Embodiment

An operation device in the embodiment generally includes an operating portion that is formed of a first conductive material and receives an operation by a user, and an operation support portion that is at least partly formed of a second conductive material, supports the operating portion in an insulated state and also displaces in an operating direction in conjunction with the operating portion due to an operation of the user, and electrostatically couples to the operating portion due to a contact of the user with the operating portion.

This operation device detects operations on the operating portion performed by a user based on electrostatic coupling between the operating portion and the operation support portion. Therefore, the number of components can be reduced and manufacturing costs can be suppressed, as compared to the case where electrodes to detect operation are attached to the operating portion with adhesive tape or glue or electric wires are connected to electrodes.

### Embodiment

### General Configuration of an Operation Device 1

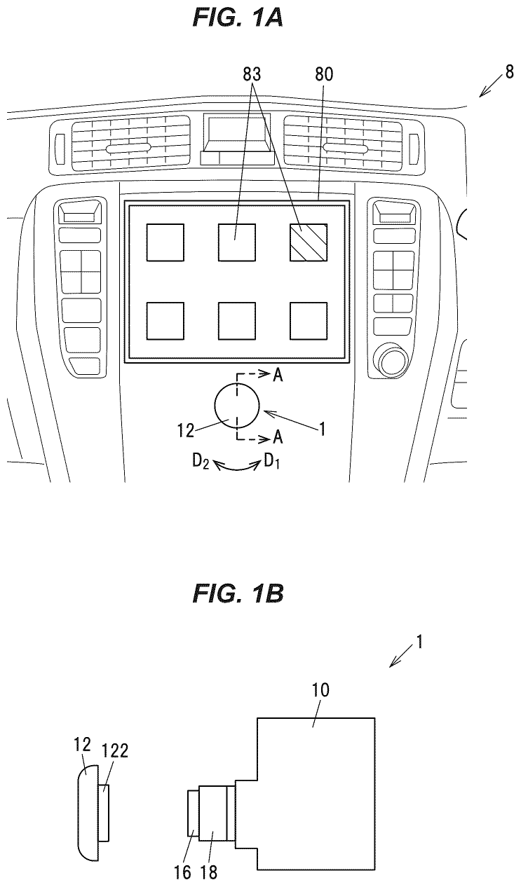

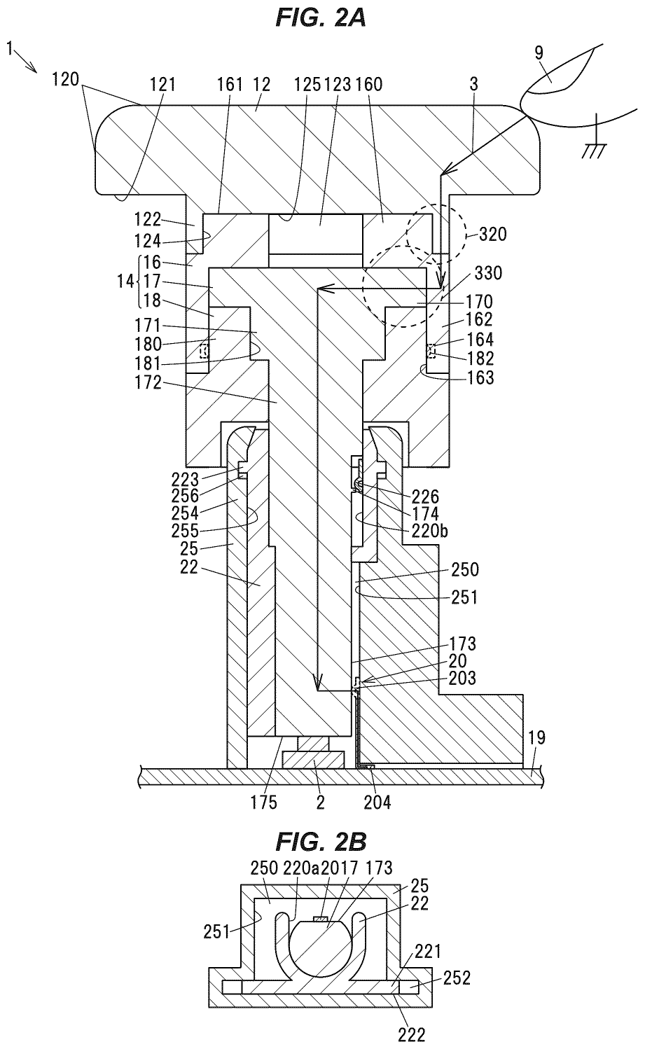

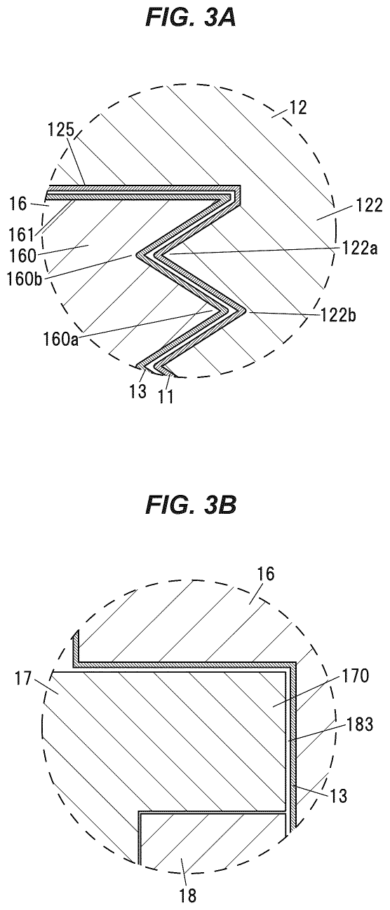

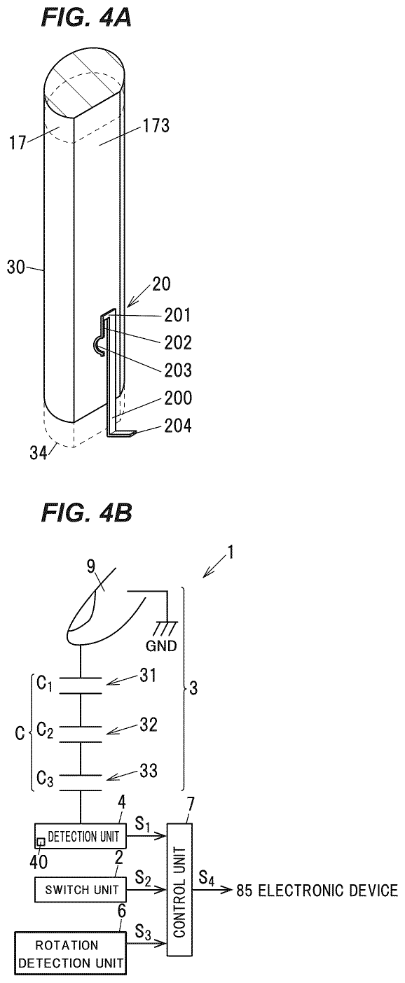

FIG. 1A is an explanatory diagram illustrating an example arrangement of an operation device in an embodiment, and FIG. 1B is an explanatory diagram illustrating an example of installation of the operation device. FIG. 2A is an example cross-sectional view showing the operation device in the embodiment when a cross section taken alone line A-A of FIG. 1A is viewed in a direction of arrow, and FIG. 2B is a cross-sectional view showing an example of contact between a shaft portion and a connection terminal. FIG. 3A is an enlarged view showing an example of a first portion of FIG. 2A in the operation device in the embodiment, and FIG. 3B is an enlarged view showing an example of a second portion of FIG. 2A. FIG. 4A is an explanatory diagram illustrating an example of electrical connection between the shaft portion and the connection terminal of the operation device in the embodiment, and FIG. 4B is an example block diagram showing the operation device. A first portion 320 and a second portion 330 are portions encircled by dotted lines in FIG. 2A.

In each drawing of the embodiment described below, a scale ratio or shape may be different between the drawings or different from the actual ratio or shape. In addition, in FIG. 4B described later, flows of main signals are indicated by arrows. Next, the general configuration of the operation device 1 will be described.

As shown in FIG. 1A, the operation device 1 in the present embodiment is mounted on a vehicle 8, and controls an electronic device 85 of the vehicle 8, as an example. The electronic device 85 is, as an example, a vehicle control device that controls settings for the entire vehicle and self-driving functions, an air conditioner that adjusts temperature inside the vehicle, a navigation device that shows a map of the current location and guides to a destination, a display device to display images, a seat device to control position and inclination of seats, and a music and video playback device to play back music and video, etc. The operation device 1 can also operate, e.g., a mobile device, etc., connected to these electronic devices 85 by wire or wirelessly.

As shown in FIGS. 1A and 1B, the operation device 1 generally includes an operating portion 12 that is formed of a first conductive material and receives an operation by a user, and an operation support portion 14 that is at least partly formed of a second conductive material, supports the operating portion 12 in an insulated state and also displaces in an operating direction in conjunction with the operating portion 12 due to an operation of the user, and electrostatically couples to the operating portion 12 due to a contact of the user with the operating portion 12.

The operation device 1 has a housing 10 to which the operation support portion 14 is attached.

At least one of the operating portion 12 and the operation support portion 14 has an insulating film, and the operating portion 12 and the operation support portion 14 electrostatically couple to each other through the insulating film.

The operating portion 12 is screw-fastened to the operation support portion 14 and, when screw-fastened, faces and electrostatically couples to the operation support portion 14 through the insulating film.

As shown in FIG. 2A, the operation support portion 14 has an attachment portion 16 which is formed of the second conductive material and to which the operating portion 12 is attached by the screw fastening, a rod-shaped shaft portion 17 that is formed of a third conductive material and is inserted into the attachment portion 16, and an insertion portion 18 that is inserted into the attachment portion 16 with the inserted shaft portion 17 sandwiched therebetween and is integrated with the attachment portion 16. The shaft portion 17 electrostatically couples to the attachment portion 16 due to an operation by the user.

The operating portion 12 in the present embodiment has a first insulating film 11 formed on a surface thereof. The attachment portion 16 of the operation support portion 14 has a second insulating film 13 formed on a surface thereof.

As shown in FIGS. 4A and 4B, the operation device 1 has a connection terminal 20 that is in contact with a side surface 173 of the shaft portion 17 and is electrically connected to the shaft portion 17, and a detection unit 4 that is electrically connected to the connection terminal 20 and detects a change in capacitance due to a contact of the user with the operating portion 12 based on first electrostatic coupling 31 between the user and the operating portion 12, second electrostatic coupling 32 between the operating portion 12 and the attachment portion 16, third electrostatic coupling 33 between the attachment portion 16 and the shaft portion 17, and electrical conduction due to the contact between the shaft portion 17 and the connection terminal 20.

As shown in FIG. 4B, the operation device 1 includes a control unit 7 that determines contact of the user based on a change in the detected capacitance.

The operation device 1 includes a switch unit 2 that is arranged under the shaft portion 17 and switches from a first state to a second state by a push operation received on the operation portion 12 and a resulting displacement of the operating portion 12 in conjunction with the attachment portion 16 and the shaft portion 17 in a direction of the push operation.

The operation device 1 also has a rotation detection unit 6 that detects a rotational operation of the operating portion 12. Next, the specific configuration of the operation device 1 will be described.

### Configuration of the Housing 10

As shown in FIG. 1B, the attachment portion 16 and the insertion portion 18 of the operation support portion 14 are exposed from the housing 10. The operating portion 12 is attached to the attachment portion 16.

### Configuration of the Operating Portion 12

The operating portion 12 is formed of, for example but not limited to, an electrical conductor such as aluminum, iron, stainless steel, and copper, etc. The operating portion 12 in the present embodiment is formed in, for example but not limited to, a disc shape using aluminum as the first conductive material. As shown in FIG. 1A, the user can perform a rotational operation of rotating the operating portion 12 in a counterclockwise direction D₁ and a clockwise direction D₂, and a push operation of pushing down the operating portion 12 toward the housing 10.

The surface of the operating portion 12 is subjected to anodizing, chemical conversion coating, painting, etc., to form an insulating film. The operating portion 12 in the present embodiment is surface-treated by anodizing and has the first insulating film 11 formed on the surface. This first insulating film 11 is, but not limited to, an aluminum oxide coating.

As shown in FIG. 2A, the operating portion 12 has a first thread portion 122 protruding from a back surface 121. As shown in FIGS. 2A and 3A, the first thread portion 122 has a cylindrical shape, and plural crests 122a and plural roots 122b are alternately formed on an opening inner surface 124 on the inner side of the first thread portion 122.

As shown in FIG. 3A, the first insulating film 11 is formed on the entire surface of the operating portion 12. Therefore, the first insulating film 11 is formed on the surfaces of the crests 122a and the roots 122b. The operating portion 12 has the first insulating film 11 also on an opening upper surface 125 of an opening 123 provided on the inner side of the first thread portion 122.

The operating portion 12 is screw-fastened so as to be easily attached to and removed from the operation support portion 14. This allows the user to easily attach his/her favorite operating portion 12.

### Configuration of the Operation Support Portion 14

The operation support portion 14 includes the attachment portion 16, the shaft portion 17 and the insertion portion 18, as described above. The attachment portion 16 and the shaft portion 17 are formed of, for example but not limited to, an electrical conductor such as aluminum, iron, stainless steel, and copper, etc. The insertion portion 18 is formed of an insulating resin material, as an example.

The attachment portion 16 in the present embodiment is formed using, for example but not limited to, aluminum as the second conductive material. The attachment portion 16 is also subjected to anodizing, chemical conversion coating, painting, etc., to form an insulating film. In the present embodiment, the second insulating film 13 is formed on the entire surface of the attachment portion 16 by applying paint, as an example. The second insulating film 13 is, for example but not limited to, an insulating film formed of an insulating resin material such as epoxy resin. The first insulating film 11 and the second insulating film 13 are formed as different films by different treatment methods, but are not limited thereto and may be formed by the same treatment method or may be the same film.

The attachment portion 16 has a cylindrical shape. The attachment portion 16 has a second thread portion 160 provided on an upper portion. The second thread portion 160 has a cylindrical shape, and plural crests 160a and plural roots 160b are alternately formed on the outer side of the cylinder, as shown in FIG. 3A. The second insulating film 13 is formed on the surfaces of the crests 160a and the roots 160b.

When the operating portion 12 and the attachment portion 16 are screwed together, the crests 122a of the operating portion 12 fit into the roots 160b of the attachment portion 16 and the crests 160a of the attachment portion 16 fit into the roots 122b of the operating portion 12, as shown in FIG. 3A. In this regard, the operating portion 12 and the attachment portion 16 may not include the thread portions as a modification, but preferably include the thread portions in view of electrostatic coupling strength.

Here, in FIG. 3A, the operating portion 12 and the attachment portion 16 are not in contact with each other, but the first insulating film 11 and the second insulating film 13 are partially in contact with each other. The first insulating film 11 and the second insulating film 13 are formed so that this contact does not result in electrical conduction between the operating portion 12 and the attachment portion 16. The first insulating film 11 and the second insulating film 13, together with the air in a gap, act as dielectrics in the second electrostatic coupling 32.

Then, as shown in FIG. 3A, the opening upper surface 125 of the operating portion 12 faces an upper surface 161 of the second thread portion 160 of the attachment portion 16.

In addition to the opening upper surface 125 and the upper surface 161 facing each other, the first thread portion 122 faces the second thread portion 160, hence, the operating portion 12 and the attachment portion 16 have a larger facing area than when the thread portions are not provided. Capacitance is proportional to the area. Therefore, the capacitance of the second capacitive coupling 32 between the operating portion 12 and the attachment portion 16 is larger than that when the thread portions are not provided.

The attachment portion 16 has an insertion hole 163 at a lower portion 162. After the shaft portion 17 is inserted into the insertion hole 163, the insertion portion 18 to be integrated with the attachment portion 16 is inserted into the insertion hole 163.

The insertion portion 18 is formed in a cylindrical shape using an insulating resin material, as an example. The insertion portion 18 has, e.g., a claw portion 182 as shown in FIG. 2A and is integrated with the attachment portion 16 by fitting the claw portion 182 into a recessed portion 164 of the attachment portion 16. This makes the operating portion 12, the attachment portion 16 and the insertion portion 18 rotatable relative to the shaft portion 17. A clearance 183 between the attachment portion 16 and the shaft portion 17 shown in FIG. 3B is provided to allow the operating portion 12 to rotate.

The shaft portion 17 is formed using iron as the third conductive material, as an example. As shown in FIG. 2A, the shaft portion 17 has an upper column 170, a middle column 171, and a lower column 172. The radius of the shaft portion 17 decreases in the order of the upper column 170, the middle column 171, and the lower column 172.

An upper insertion portion 180 of the insertion portion 18 is inserted into the insertion hole 163 of the attachment portion 16. As shown in FIG. 2A, a shaft insertion hole 181 of the insertion portion 18 includes an upper-side hole corresponding to the middle column 171 of the shaft portion 17 and a lower-side hole corresponding to the lower column 172 of the shaft portion 17, with the radius of the lower-side hole being smaller than that of the upper-side hole.

As shown in FIGS. 2A and 4A, the lower column 172 of the shaft portion 17 has the side surface 173 in contact with the connection terminal 20. The side surface 173 is not a curved surface of the column but is a vertically long flat surface. As shown in FIG. 4A, the side surface 173 is formed so that contact with the connection terminal 20 can be maintained even when the operating portion 12 is push-operated.

A push operation position 34 shown in FIG. 4A is an operation position of the operating portion 12 when push-operated. The side surface 173 of the shaft portion 17 maintains the contact with the connection terminal 20 even at the push operation position 34, as shown in FIG. 4A. In this regard, the position of the operating portion 12 when no operation is performed is an initial position 30.

### Configuration of the Connection Terminal 20

The connection terminal 20 is formed as a plate spring, using an electrical conductor such as stainless steel or copper. The connection terminal 20 in the present embodiment is formed using, for example but not limited to, copper. The surface of the connection terminal 20 is plated with gold.

As shown in FIG. 4A, the connection terminal 20 includes a base portion 200, a bent portion 201, a bent-back portion 202, a contact portion 203, and a substrate attachment portion 204. The connection terminal 20 has such a shape that an elongated plate is bent back at the bent portion 201 and the bent-back portion 202. The connection terminal 20 is formed by an etching method, as an example.

As shown in FIG. 2A, the connection terminal 20 is attached to an inner surface 251 of a housing portion 250 of an inner housing 25 (described later). The bent-back portion 202 is formed with the contact portion 203 that protrudes toward the shaft portion 17. The contact portion 203 is pressed against the side surface 173 mainly by an elastic force of the bent-back portion 202. The substrate attachment portion 204 is screw-fixed to a substrate 19 and is connected to wiring on the substrate 19.

### Configuration of a Shaft Holding Potion 22

As shown in FIGS. 2A and 2B, the shaft holding portion 22 includes a flange 221, a shank portion 223, and a plate spring 226. The shaft holding portion 22 is formed using a resin material, as an example.

As shown in FIG. 2B, the shaft holding portion 22 has a slit 220a through which the side surface 173 of the shaft portion 17 is exposed. The slit 220a has a vertically elongated shape. The connection terminal 20 is in contact with the side surface 173 exposed in the slit 220a.

As shown in FIG. 2B, the flange 221 is provided on the shaft holding portion 22 on a side opposite to the slit 220a, and has a plate shape. The flange 221 is inserted into a guide portion 252 of the inner housing 25 (described later) and guides the movement of the operating portion 12 in the push operation direction.

As shown in FIG. 2A, the shank portion 223 is inserted into a support recess 256 of the inner housing 25. The support recess 256 has an elongated shape in such a manner that the shaft holding portion 22 can move when a pushing operation is performed.

As shown in FIG. 2A, the plate spring 226 is attached to an inner surface 220b of the shaft holding portion 22. When the shaft portion 17 is inserted into the shaft holding portion 22, the plate spring 226 comes into contact with a claw portion 174 of the shaft portion 17 and elastically deforms, and after the claw portion 174 climbs over the plate spring 226 and the insertion is completed, the plate spring 226 returns to its original shape. As a result, the shaft portion 17 is held so as not to come out of the shaft holding portion 22.

The shaft portion 17 is arranged so that a lower surface 175 is in contact with the switch unit 2. When a push operation is performed on the operating portion 12, the shaft portion 17 moves with the operating portion 12, the attachment portion 16 and the insertion portion 18, and switches the state of the switch unit 2 from the first state to the second state. When the pushing operation is completed, the operating portion 12 returns to the initial position 30 of the pre-push operation due to the elastic force of the switch unit 2, etc.

### Configuration of the Inner Housing 25

The inner housing 25 is formed using a resin material, as an example. The inner housing 25 houses the shaft holding portion 22 in the housing portion 250.

The inner housing 25 has the support recess 256 that is formed on an inner surface 255 of an upper portion 254 and is long in the push operation direction. The shank portion 223 of the shaft holding portion 22 is inserted into the support recess 256, which allows the shaft holding portion 22 to move in the push operation direction.

An end of the upper portion 254 of the inner housing 25 is narrowed toward the shaft portion 17 and is narrower than the shaft holding portion 22, which suppresses coming out of the shaft holding portion 22.

### Configuration of the Switch Unit 2

As shown in FIG. 2A, the switch unit 2 is arranged on the substrate 19. As an example, the switch unit 2 is a momentary switch that is in the first state before push operation and switches to the second state after push operation. In the present embodiment, the first state is an OFF state and the second state is an ON state. As shown in FIG. 4B, the switch unit 2 is electrically connected to the control unit 7.

The switch unit 2, when switched from the OFF state to the ON state, outputs a switch signal S₂ to the control unit 7.

### Configuration of the Detection Unit 4

The detection unit 4 detects a change in capacitance caused by contact with an operating surface 120 of the operating unit 12. When an operating finger 9 of the user comes into contact with the operating surface 120 of the operating portion 12, an electrostatic circuit 3 shown in FIGS. 2A and 4B is formed.

The electrostatic circuit 3 is a circuit formed by the operating finger 9 (GND), the first electrostatic coupling 31, the second electrostatic coupling 32, and the third electrostatic coupling 33. The first electrostatic coupling 31 is an electrostatic coupling that occurs between the operating finger 9 and the operating portion 12. The second electrostatic coupling 32 is an electrostatic coupling that occurs between the operating portion 12 and the attachment portion 16. The third electrostatic coupling 33 is an electrostatic coupling between the attachment portion 16 and the shaft portion 17. In this way, the electrostatic circuit 3 is a circuit that can be formed without connecting between the operating portion 12 and the attachment portion 16 and between the attachment portion 16 and the shaft portion 17 by electric wires.

A capacitance C to be detected is a combined capacitance of a first capacitance C₁, a second capacitance C₂, and a third capacitance C₃ connected in series, and is expressed by the following equation:

$$C = ( {C}_{1} {C}_{2} {C}_{3} ) / ( {C}_{1} {C}_{2} + {C}_{2} {C}_{3} + {C}_{1} {C}_{3} )$$

The detection unit 4 has an electrostatic threshold 40. The detection unit 4 compares the obtained capacitance C with the electrostatic threshold 40 to determine whether the operating finger 9 has come into contact with the operating portion 12. The detection unit 4, when detected a contact, outputs a detection signal S₁ to the control unit 7. The detection unit 4 is configured to be periodically connected to a ground circuit and reset a parasitic capacitance.

### Configuration of the Rotation Detection Unit 6

The rotation detection unit 6 is, e.g., a rotation sensor such as rotary encoder. The rotation detection unit 6 is electrically connected to the control unit 7. The rotation detection unit 6 outputs a rotation angle signal S₃ corresponding to a detected rotation angle of the operating portion 12 to the control unit 7.

### Configuration of the Control Unit 7

The control unit 7 is, e.g., a microcomputer composed of a CPU (Central Processing Unit) performing calculation and processing, etc., of the acquired data according to a stored program, and a RAM (Random Access Memory) and a ROM (Read Only Memory) as semiconductor memories, etc. The ROM stores, e.g., a program for operation of the control unit 7. The RAM is used as, e.g., a storage area to temporarily store calculation results, etc.

When a contact with the operating portion 12, i.e., a touch operation on the operating portion 12 is detected based on the detection signal S₁ output from the detection unit 4, the control unit 7 determines presence or absence of a push operation and a rotation operation based on the switch signal S₂ obtained from the switch unit 2 and the rotation angle signal S₃ obtained from the rotation detection unit 6. Then, when an operation is detected, the control unit 7 generates a control signal S₄ corresponding to the operation and outputs it to the electronic device 85 to be controlled.

For example, a user selects a desired option from plural images 83 displayed on a monitor 80 and gives an instruction for execution thereof. At this time, the user selects a desired option from the plural images 83 by rotationally operating the operating portion 12 and performs a push operation on the operating portion 12, and thereby can cause the electronic device 85 to execute the function assigned to the desired option. In FIG. 1A, as an example, the selected image 83 is shaded. When the user performs a push operation in this state, the function assigned to the shaded image 83 is executed.

When, e.g., a push operation is performed after a rotational operation, the control unit 7 outputs the control signal S₄ corresponding to the rotational operation based on the rotation angle signal S₃ that is obtained from the rotation detection unit 6 after a contact with the operating portion 12 is detected based on the detection signal S₁ obtained from the detection unit 4. The control unit 7 then outputs the control signal S₄ corresponding to the push operation based on the switch signal S₂ obtained from the switch unit 2. The electronic device 85 executes the function assigned to the desired option based on the obtained control signal S₄.

### Effects of the Embodiment

The operation device 1 in the present embodiment can suppress manufacturing costs. In particular, since the operation device 1 is configured such that the operating portion 12 is attached to the attachment portion 16 by screw fastening and is electrically connected to the detection unit 4 by electrostatic coupling therebetween, the number of components is reduced and manufacturing costs are suppressed, as compared to the case where electrodes to detect contact are attached to the operating portion with glue or adhesive tape.

In the operation device 1, the shaft portion 17, which moves due to rotational operation or push operation, can be electrically connected to the detection portion 4 through the connection terminal 20. Therefore, electrical conduction failure due to wire breakage does not occur, as compared to the case where the shaft portion and the detection portion are connected by an electric wire.

The operation device 1 can accept touch, rotational and push operations on the operating portion 12 by means of the first electrostatic coupling 31 to the third electrostatic coupling 33 without arranging electrodes on the operating portion 12.

The operation device 1 accepts operations performed after contact with the operating portion 12 is detected. Therefore, as compared to the case where this configuration is not adopted, it is possible to suppress erroneous determinations such as the case where an object colliding with the operating portion 12 causes an operation to be deemed to have been performed.

As compared to the case where electrodes are placed on the operating portion and an electric wire exposed from the housing is connected to the electrodes for assembly, it is easier to assemble the operation device 1 since the operating portion 12 can be easily attached to the housing 10.

Since the operating portion 12 of the operation device 1 can be easily replaced, it is easier to attach a user's favorite operating portion 12 or an operating portion 12 with superior design, as compared to the case where replacement is not possible. In addition, since the operating portion 12 of the operation device 1 can be easily replaced, it is possible to flexibly adapt to design changes, etc., according to the grade of the vehicle, as compared to the case where replacement is not possible.

Although the embodiment and modification of the invention have been described, the embodiment and modification are merely examples and the invention according to claims is not to be limited thereto. These new embodiment and modification may be implemented in various other forms, and various omissions, substitutions and changes, etc., can be made without departing from the gist of the invention. In addition, not all combinations of the features described in the embodiment and modification are necessary to solve the problem of the invention. Further, these embodiment and modification are included within the scope and gist of the invention and also within the invention described in the claims and the range of equivalency.

### REFERENCE SIGNS LIST

1 OPERATION DEVICE
2 SWITCH UNIT
3 ELECTROSTATIC CIRCUIT
4 DETECTION UNIT
6 ROTATION DETECTION UNIT
7 CONTROL UNIT
10 HOUSING
11 FIRST INSULATING FILM
12 OPERATING PORTION
13 SECOND INSULATING FILM
14 OPERATION SUPPORT PORTION
16 ATTACHMENT PORTION
17 SHAFT PORTION
18 INSERTION PORTION
20 CONNECTION TERMINAL
31-33 FIRST ELECTROSTATIC COUPLING - THIRD ELECTROSTATIC COUPLING
80 MONITOR
81 DISPLAY SCREEN
83 IMAGE
122 FIRST THREAD PORTION
160 SECOND THREAD PORTION

1. An operation device, comprising:
an operating portion that comprises a first conductive material and receives an operation by a user; and
an operation support portion that at least partly comprises a second conductive material, supports the operating portion in an insulated state and also displaces in an operating direction in conjunction with the operating portion due to an operation of the user, and electrostatically couples to the operating portion due to a contact of the user with the operating portion.

2. The operation device according to claim 1, wherein at least one of the operating portion and the operation support portion comprises an insulating film, and the operating portion and the operation support portion electrostatically couple to each other through the insulating film.

3. The operation device according to claim 2, wherein the operating portion is screw-fastened to the operation support portion and, when screw-fastened, faces and electrostatically couples to the operation support portion through the insulating film.

4. The operation device according to claim 3, wherein the operation support portion comprises an attachment portion which comprises the second conductive material and to which the operating portion is attached by the screw fastening, a rod-shaped shaft portion that comprises a third conductive material and is inserted into the attachment portion, and an insertion portion that is inserted into the attachment portion with the inserted shaft portion sandwiched therebetween and is integrated with the attachment portion, and wherein the shaft portion electrostatically couples to the attachment portion due to an operation by the user.

5. The operation device according to claim 4, comprising:
a connection terminal that is in contact with a side surface of the shaft portion and is electrically connected to the shaft portion; and
a detection unit that is electrically connected to the connection terminal and detects a change in capacitance due to a contact of the user with the operating portion based on first electrostatic coupling between the user and the operating portion, second electrostatic coupling between the operating portion and the attachment portion, third electrostatic coupling between the attachment portion and the shaft portion, and electrical conduction due to the contact between the shaft portion and the connection terminal.

6. The operation device according to claim 5, further comprising a switch unit that is arranged under the shaft portion and switches from a first state to a second state by a push operation received on the operating portion and a resulting displacement of the operating portion in conjunction with the attachment portion and the shaft portion in a direction of the push operation.

7. The operation device according to claim 5, wherein the side surface of the shaft portion in contact with the connection terminal comprises a flat surface which is formed so as to maintain contact with the connection terminal during a push operation received on the operating portion.

8. The operation device according to claim 5, wherein the connection terminal comprises a resilient part which is formed so as to press the connection terminal against the side surface of the shaft portion during a push operation received on the operating portion.

9. The operation device according to claim 5, further comprising a shaft holding portion into which the shaft portion is inserted, wherein the shaft holding portion comprises a slit which is formed so as to expose therethrough the side surface of the shaft portion in contact with the connection terminal.

10. The operation device according to claim 5, further comprising a shaft holding portion into which the shaft portion is inserted, wherein the shaft holding portion comprises a flange which is formed so as to guide movement of the operating portion in a direction of the push operation during a push operation received on the operating portion.
